(19) United States
(12) Patent Application Publication
(10) Pub. No.: US 2026/0280254 A1
(43) Pub. Date: Sep. 17, 2026

(54) MILKING UNIT WITH A SEALED HOUSING

(71) Applicant: GEA Farm Technologies GmbH, Bönen (DE)

(72) Inventors: Thomas Troppmann, Sassenberg (DE); Jörg-a Lambke, Beckum (DE); Markus Auburger, Lippstadt (DE); Uwe Feddermann, Warstein (DE); Adib Matty, Essen (DE)

(21) Appl. No.: 18/876,021

(22) PCT Filed: Jul. 12, 2023
(86) PCT No.: PCT/EP2023/069299

§ 371 Date: Dec. 17, 2024

(30) Foreign Application Priority Data
Jul. 18, 2022 (DE) 20 2022 104 035.4

(51) Int. Cl. H02G 3/22; A01J 5/007

(52) U.S. Cl. CPC H02G 3/22; A01J 5/007

(57) ABSTRACT

The invention relates to a milking device comprising a milking unit and at least one electrical unit connected to the milking unit and arranged in a housing. The housing has an interior delimited by a front (17) and a box structure. The interior is divided into two—a first and a second chamber (25.1, 25.2)—wherein the first and the second chambers (25.1, 25.2) are connected to one another and spaced apart from a base region. The first chamber (25.1) has a sealingly designed through-opening (27) through which a cable (28) extends into the second chamber (25.2). The electrical unit is arranged in the second chamber (25.2) and connected to the cable (28).

The invention relates to a milking device. Although the invention is described below in connection with a milking device for milking cows, attention is drawn to the fact that the subject matter of the invention refers, in particular, also to milking devices for milking sheep, goats, llamas, camels, dromedaries, buffaloes, mares, assess or yaks. The invention can be used both on fully automatic and on semiautomatic milking devices.

A dairy farm has numerous systems that are of importance for dairy livestock keeping. A milking parlor can have a plurality of milking stations, each of which is equipped with a milking unit. The milking unit has at least one milking cup, which is connected via a long milk hose to a milk transfer line. The prior art also includes milking units in which the milking cups are each connected via a short milk hose to a milk collecting container, wherein the milk collecting container is connected via a long milk hose, possibly with the interposition of a measuring cup or measuring container, to the milk transfer line.

Milking units are operated under specified operating conditions, which may include, for example, the milking vacuum or clock frequency of a pulsator.

The milking unit is connected to at least one electrical unit. The electrical unit may be, for example, a controller which is suitable and intended for controlling the start of a milking process, the end of a milking process or other operating parameters of the milking unit, for example. The electrical unit may also involve units by means of which the milking cups are removed on completion of the milking process, for example.

The provision of a milking unit at a milking station is known. With the aim, in particular, of avoiding long electric cables, numerous electrical units or components are arranged in the region of the milking station. The milking station may also have a corresponding operating panel, by means of which commands are input manually into the electrical unit. The operating panel may also have corresponding optical means, via which information is communicated to the operator, in particular the dairy worker.

In view of the fact that contamination may also occur at the milking station and in order to maintain the prerequisites for hygiene at the milking station, there is a known practice of

cleaning the milking station as such at specified intervals or according to need. This cleaning of the milking station is often carried out by means of high pressure water cleaning agents. Such a cleaning method requires great care, in particular to ensure that the high pressure water jet does not get into the region of a housing in which at least one electrical unit is arranged and which has leadthroughs for cables, and make contact. However, it is not always possible to avoid this in practice, and therefore there is the risk that water or cleaning agent will get into the housing in which at least one electrical unit is arranged. This can lead to impairment of the functionality of the electrical unit in the housing.

Taking this as a starting point, it is the underlying aim of the present invention to specify a milking device; the operational reliability of which is increased.

This object is achieved by a milking device having the features of patent claim 1. Further advantageous embodiments of the invention are indicated in the dependent patent claims. The features listed individually in the patent claims can be combined with one another in any technologically feasible manner and can be supplemented by explanatory facts from the description, indicating further embodiments of the invention.

According to an inventive concept, a milking device is proposed, comprising a milking unit and at least one electrical unit connected to the milking unit and arranged in a housing.

As described at the outset, the milking unit has at least one milking cup, which is connected via a long milk hose to a milk transfer line. There is also the possibility that the milking unit has at least two milking cups, which are each connected via a short milk hose to a milk collecting container, wherein the milk collecting container is connected directly or indirectly, via a long milk hose, to the milk transfer line.

The milking cup per se has a milking cup sleeve, in which what is referred to as a teat rubber is arranged. The short milk hose and the teat rubber may be designed as separate parts.

Integral construction of the teat rubber and the short milk hose is also known, and, in such a case, specialists refer to a “monobloc”.

The electrical unit that is arranged in the housing can be a controller, a switch, an electric circuit etc. This electrical unit is arranged in a housing which has at least one sealed leadthrough.

The housing has an interior delimited by a front and a box structure. The interior of the housing has a first and a second chamber. The first and the second chamber are connected to one another in a region which is at a distance from a base region of the housing. At this point, it should be noted that, apart from the connecting region, the first and the second chamber are separated liquid-tightly from one another. The first chamber has a sealing leadthrough, through which a cable extends into the second chamber. The electrical unit is arranged in the second chamber and connected to the cable.

The cable is an electric lead, by means of which power or information is transmitted. The electric lead can have one or more cores. It is also possible for the cable to be an optical conductor.

By means of the embodiment according to the invention of the milking device, increased operational reliability of the milking device is achieved. If, for example, a water jet traveling at high speed strikes the leadthrough, a situation where water can get into the first chamber is avoided by means of the leadthrough, which has a sealing effect. If water does enter nevertheless, the division of the interior of the housing into a first and a second chamber ensures that crossover of the water from the first chamber to the second chamber is avoided. This is of particular advantage especially in the case of vertical arrangement of the housing, wherein the first chamber and the second chamber are separated vertically from one another.

The embodiment according to the invention of the milking device also has the advantage that the assembly effort on site can be reduced. Thus, the housing can already be pre-fitted with corresponding cables. The cables may also be already preassembled. This means that the cables are equipped with appropriate terminals. The housing preassembled in this way can then be secured on a corresponding carrier and connected to the corresponding additional components of the milking unit in situ, that is to say at the milking station at which the milking device is to be installed.

The sealing leadthrough through which a cable extends is preferably achieved by form-fitting and/or force-fitting engagement. The operational reliability of the milking device can be even further enhanced by the fact that the cable extends through at least two leadthroughs arranged spaced apart from one another. Thus, in the case where water gets through the first sealing leadthrough, it must also get through the second leadthrough, which follows the first and is of sealing design. However, this is reduced by the sealing effect of the two leadthroughs to such an extent that liquid cannot get from the first into the second chamber.

If a plurality of spaced-apart sealing leadthroughs is provided for a cable guide, it is also possible for the housing to be positioned in a plane other than the vertical.

There is a particular preference for an embodiment of the milking device in which the leadthrough has two sealing lips, which are spaced apart from one another and fit around the cable. A leadthrough which has a high sealing effect with respect to the cable is thereby obtained in an advantageous manner. The sealing lips fit around the cable in a sealing manner. The sealing lips are preferably produced from an elastic material, ensuring that the sealing lips rest against a sheath of the cable not only with form-fitting engagement but also with force-fitting engagement.

An embodiment of the milking device in which the leadthrough has a holding element and a sealing element is particularly advantageous. The holding element has a groove which fits partially around the cable. The sealing element has a passage, through which the cable extends. The holding element and the sealing element are arranged adjacent to one another.

Such an embodiment of the leadthrough is particularly advantageous when a plurality of cables are inserted into the housing. Thus, the holding element has a number of grooves corresponding to the number of cables. In corresponding fashion, the sealing element has a number of passages corresponding to the number of cables and thus also to the number of grooves. In such an embodiment of the leadthrough, a high flexibility of assembly and equipment of the housing is achieved.

There is a preference in this context for the embodiment of a sealing element which has a slot that extends from a surface of the sealing element into the passage. It is thus not necessary to pass the cable through the passage. There is the possibility of inserting the cable into the passage through the slot. This also has the advantage that the assembly effort is simplified while ensuring leaktightness.

To increase the sealing effect, provision is made, according to an advantageous embodiment of the milking device, for a sealing element to be arranged between two holding elements when viewed in the longitudinal direction of the cable. The two holding elements and the sealing element can form a structural unit, such that, for example, the cable is first inserted into the two holding elements and then the sealing element is positioned between the two holding elements, whereupon the cables pass through the slots into the passage of the sealing element. In such an embodiment of the milking device, it is advantageous if the holding element and the sealing element have a configuration such that the sealing element can be inserted between the two holding elements with a certain prestress, and the surfaces of the holding elements and of the sealing element rest against one another. This can be achieved, for example, by the holding elements and the sealing element having a triangular cross section. In this case, one side face of the sealing element rests against one holding element, and the other side face of the sealing element rests against a side face of the other holding element.

According to another advantageous embodiment of the milking device, it is proposed that a dividing wall, which is arranged in the interior of the housing, is provided, wherein the dividing wall has an opening which is spaced apart from the base region and through which a cable can be passed from the first to the second chamber.

The dividing wall can be arranged, for example, between the box structure and the front of the housing. The dividing wall, the front and the box structure are preferably connected to one another in a sealing manner. For this purpose, a peripheral seal, which is arranged on the rim of the dividing wall, can be provided. The front is preferably of hood-shaped design. The front, the dividing wall and the box structure are connected to one another by appropriate fastening means or holding means. Thus, there is the possibility of already mounting the at least one electrical unit on the dividing wall and, in that location, on that surface of the dividing wall which faces the second chamber, thus enabling the dividing wall, the electrical unit, which is fitted with appropriate terminals, to be brought to the milking station already in the preassembled state for incorporation there into the final assembly of the milking station.

According to another inventive concept, a housing for accommodating an electrical unit in a milking device is proposed, wherein the housing has an interior, which is delimited by a front and a box structure and is divided into a first and a second chamber. The first and the second chamber are connected to one another at a distance from a base region. The first chamber has a sealing leadthrough, through which a cable can be extended into the second chamber, wherein the chamber has fastening means for fastening an electrical unit.

A housing for use in a milking device, which housing, in particular, achieves increased operational reliability of the at least one electrical unit, which may be situated in the housing, is thereby provided.

The housing can advantageously be designed in accordance with claims 2 to 7.

Further details and advantages of the invention are explained with reference to the figures illustrated in the drawing without restricting the subject matter of the invention to the specific illustrations in the figures. In the drawing:

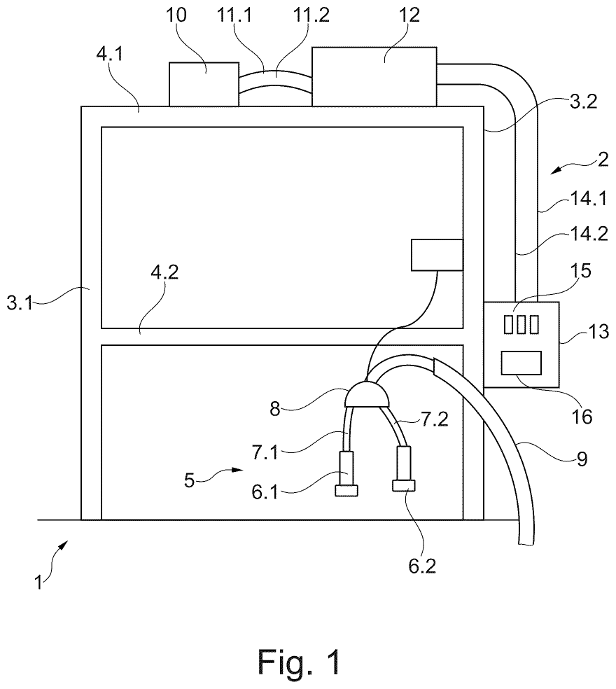

FIG. 1: shows schematically a milking station with a milking device,

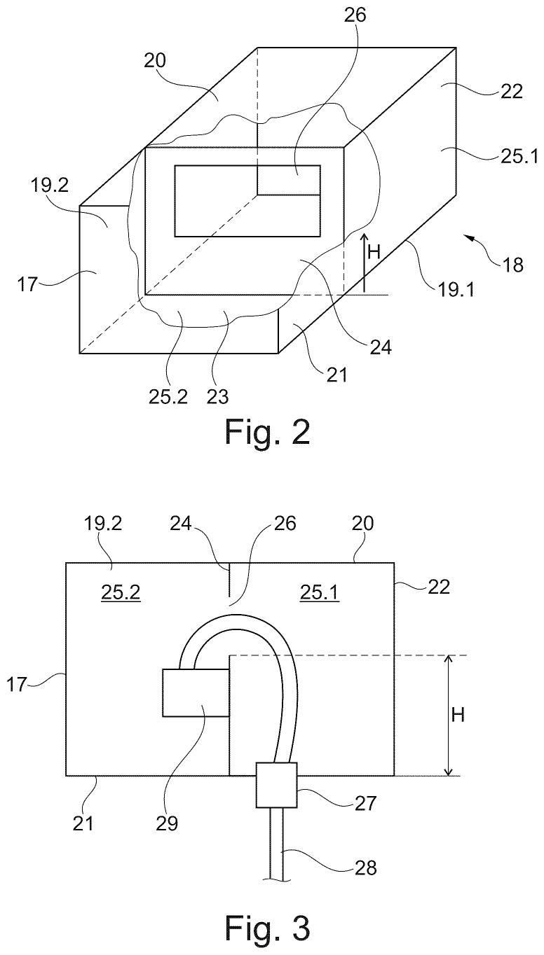

FIG. 2: shows schematically and in perspective a housing with cutaway sections,

FIG. 3: shows schematically and in perspective a housing according to FIG. 2,

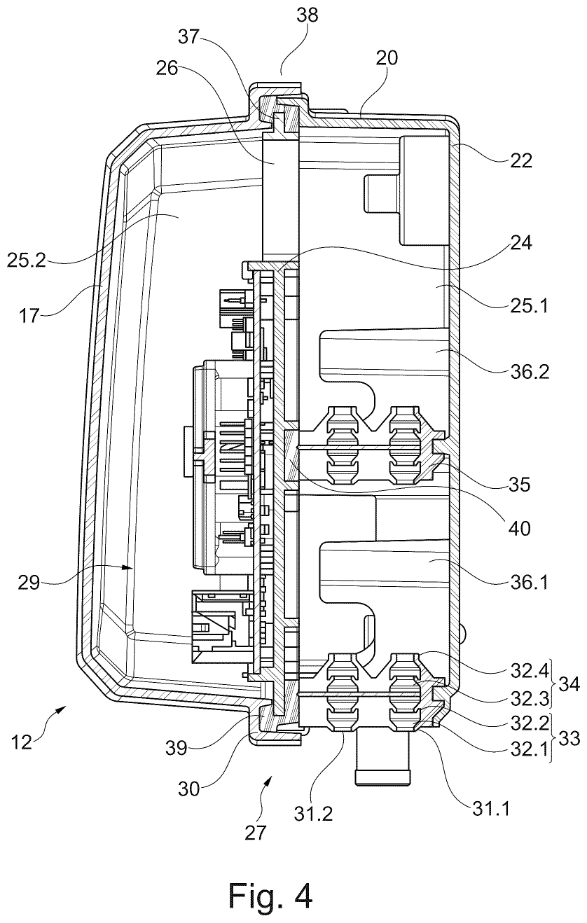

FIG. 4: shows a second exemplary embodiment of a housing in cross section,

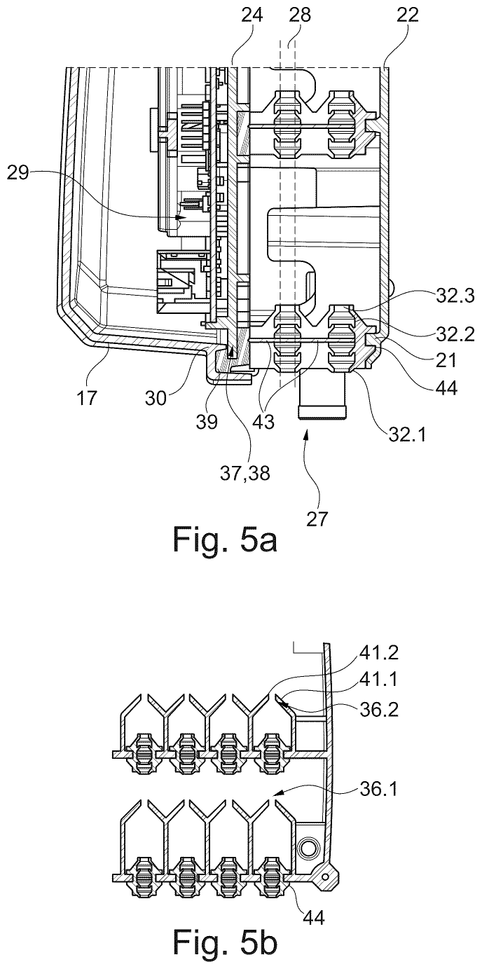

FIG. 5: shows a detail of a housing in perspective and in section,

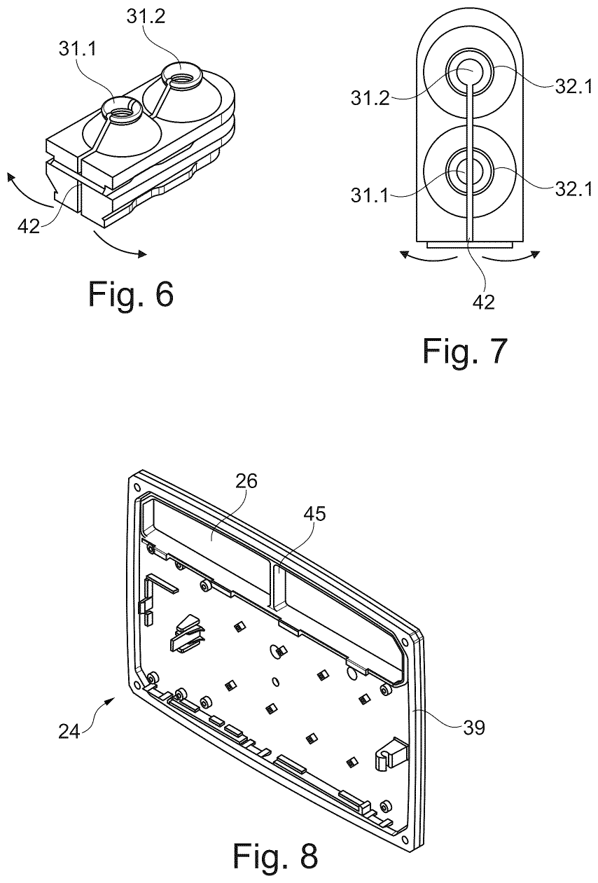

FIG. 6: shows a sealing leadthrough in perspective,

FIG. 7: shows the leadthrough according to FIG. 6 in a plan view,

FIG. 8: shows an embodiment of a dividing wall with a seal,

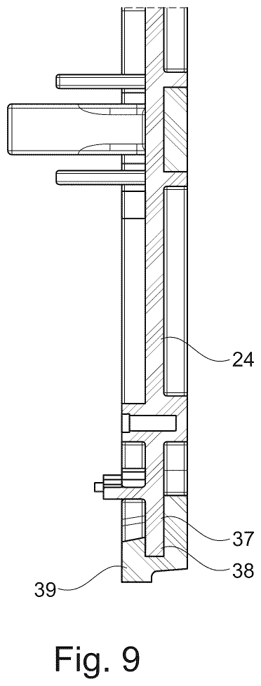

FIG. 9: shows a detail of the dividing wall with a seal according to FIG. 8 in a perspective view,

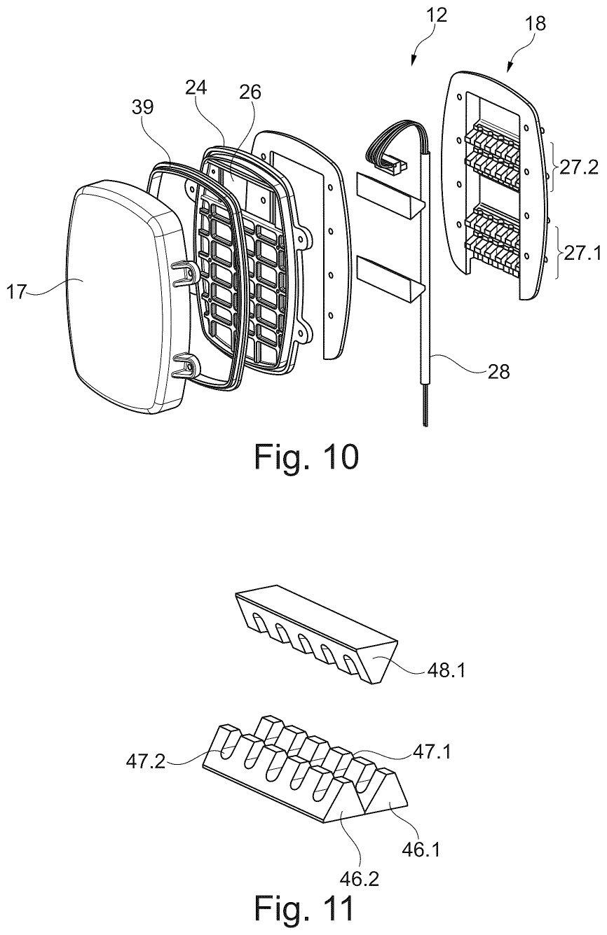

FIG. 10: shows another exemplary embodiment of a housing,

FIG. 11: shows the leadthrough according to FIG. 10,

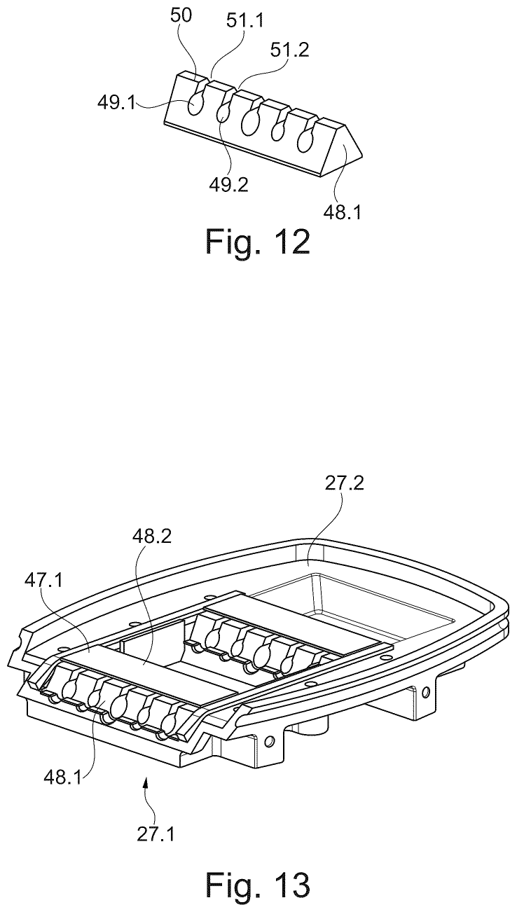

FIG. 12: shows a sealing element of the leadthrough according to FIG. 10,

FIG. 13: shows part of a housing in perspective,

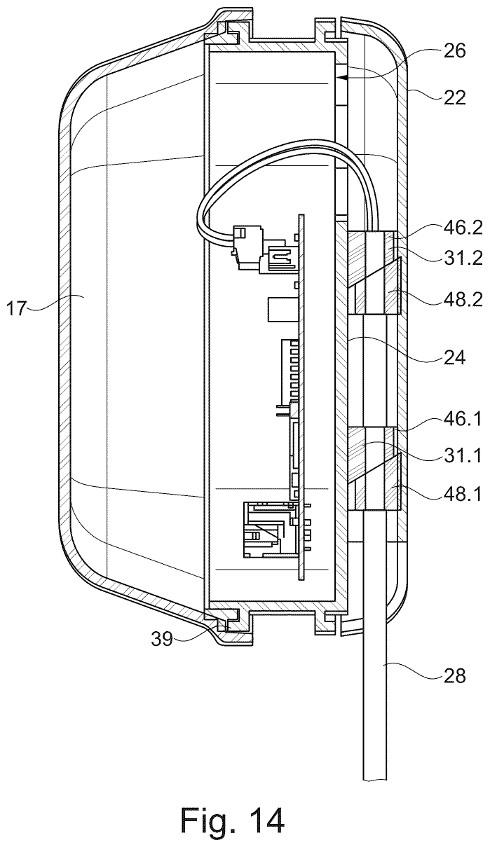

FIG. 14: shows in perspective and schematically another exemplary embodiment of a housing.

FIG. 1 illustrates schematically a milking station 1 for milking an animal, in particular a cow. The milking station 1 can be an individual milking station, a group milking station or a milking station on a milking carousel. The milking station 1 is delimited by a grating structure 2. The configuration of such a grating structure 2 is dependent on whether this is a milking station, e.g. on a milking station on a milking carousel, or an individual milking station or a milking station on a group milking parlor.

The grating structure is formed by posts 3.1, 3.2, which extend in a vertical direction. Additional posts that are not illustrated may be present. Substantially horizontally running tubes 4.1, 4.2 are connected to the posts 3.1, 3.2. The tubes 4.1, 4.2 delimit the milking station, as far as required, in the longitudinal direction of the milking station and transversely to the longitudinal direction of the milking station. A grating structure of this kind can also be used as a fastening means for fastening additional components located in the milking station.

In the exemplary embodiment illustrated, the milking station 1 has a milking unit 5. The milking unit 5 has milking cups 6.1 and 6.2. This is a milking station for milking cows, although only two of the four milking cups are illustrated. The milking cups 6.1, 6.2 are each connected to a milk collector 8 via a short milk hose 7.1, 7.2. The milk collector or milk collecting container is connected via a long milk hose 9 to a milk transfer line (not illustrated).

A pulsator 10 is connected to the milking unit 5. The corresponding vacuum and air lines that connect the pulsator 10 to the milking cups 6.1, 6.2 are not illustrated for the sake of clarity. A corresponding distributor can be provided on the milk collector 8, and therefore just one fluid line is passed from the pulsator 10 to the milking unit 5. The pulsator 10 is connected via cables 11.1, 11.2 to a controller (not illustrated) for the milking process and thus also for the milking station. The controller is arranged in a housing 12.

In the exemplary embodiment illustrated, the pulsator 10 and the housing 12 are fastened to a horizontally running tube 4.1. This is one possibility. There are also the possibilities of fastening the pulsator and the housing to the controller at other locations.

An operating terminal 13 is provided for the operation of the milking station. The operating terminal 13 is connected via signal lines 14.1, 14.2 to the controller arranged in the housing 12.

Where the terms “electric lead”, “signal line” or “cable” are used above or below, these are electrically conductive cables by means of which energy or signals are transmitted.

The operating terminal 13 has operating buttons 15, by means of which information can be called up from the controller. The information can be displayed by means of the display 16 on the operating terminal. The operating buttons 15 can also be buttons by means of which individual processes during a milking process can be started or ended. For example, there can be an operating button for ending the milking process, by means of which, by way of the controller, an automatic removal system is activated, resulting in the removal of the attached milking cups from the teats of the animal.

In FIG. 2, a housing 12 is illustrated in perspective, schematically and in cutaway view. The housing 12 has a front 17 and a box structure 18. The box structure 18 is formed by side walls 19.1, 19.2, which are spaced apart from one another. The side walls 19.1, 19.2 are connected to a top wall 20 and a base 21. A rear wall 22 is also provided.

The box structure 18 thus formed and the front 17 delimit an interior 23. From the illustration in FIG. 2, it can be seen that a dividing wall 24 is provided within the housing 12. The dividing wall 24 divides the interior 23 into a first chamber 25.1 and a second chamber 25.2. At a distance from a region of the base 21, the dividing wall 24 has an opening 26. The opening 26 connects the first chamber 25.1 to the second chamber 25.2. It should be noted that the dividing wall may also be designed in such a way that it extends from a base 21 over part of the height H of the housing when viewed in the vertical direction. The dividing wall 24 extends over the entire width of the interior 23 of the housing 12.

FIG. 3 shows the housing 12 in a sectional illustration. From the sectional illustration, it can be seen that a leadthrough 27 is arranged in the base 21 of the first chamber 25.1. A cable 28 extends through the leadthrough 27 into the first chamber 25.1. The cable 28 extends through the opening 26 into the second chamber 25.2. An electrical unit 29, which is connected to the cable 28, is arranged in the second chamber 25.2.

The cable 28 can be a supply line, signal line or the like, wherein the cable is electrically conductive. It is also possible for the cable to be an optical line. For example, the cable can be connected to the pulsator 10 and/or to the operating terminal 13.

The leadthrough 27 is arranged in the base 21. The cable 28 is sealed by the leadthrough 27. The housing 12 is preferably arranged in such a way that the dividing wall 24 lies substantially in a vertical plane.

If, for example, a jet of water strikes the leadthrough 27 at high pressure, the leadthrough 27 acts as a flow resistor, and therefore substantially no water should penetrate into the first chamber 25.1. However, if it should happen that, on account of deformation of the leadthrough 27 and/or of the cable 28, water enters the first chamber 25.1, the dividing wall 24, which extends in a vertical direction from the base 21 towards the top wall 20, acts as a bulkhead, which separates the second chamber 25.2 from the first chamber 25.1, thus reducing the risk of water ingress into the second chamber 25.2, thereby reducing the possibility of contact between the water and the electrical unit 29 and thus increasing the operational reliability of the milking device.

FIG. 4 shows a second exemplary embodiment of a housing 12. Identical parts are provided with identical reference signs, as is the case in FIGS. 2 and 3.

In the second embodiment of the housing 12, this has a hood-type front 17 with a peripheral rim 30. In the exemplary embodiment illustrated, the housing has a leadthrough 27 with two leadthrough openings 31.1, 31.2. The leadthrough openings 31.1, 31.2 each have a circular cross section, which is intended for cables with a circular cross section. In the exemplary embodiment illustrated, the leadthrough openings 31.1, 31.2 extend in a vertical direction. The leadthroughs 31.1 and 31.2 are formed substantially parallel to one another. In the exemplary embodiment illustrated, each leadthrough 31.1, 31.2 has four sealing lips 32.1-32.4. The sealing lips 32.1, 32.2 form a first seal pair 33. The sealing lips 32.3, 32.4 form a second seal pair.

The sealing lips of the first seal pair 33 form a rim of a cone which tapers away from the first chamber 25.1. The sealing lips 32.3, 32.4 of the second seal pair 34 form a rim of the respective cone which tapers toward the top wall 20.

From FIG. 4, it can be seen that a further leadthrough 35 is provided between the base 21 and the top wall 20. The further leadthrough 35 corresponds to the leadthrough 27 which is arranged in the base 21.

A first tension relief unit 36.1 is provided between the leadthroughs 27 and 35. A second tension relief unit 36.2 is provided above the second leadthrough 35 but in front of and below the opening 26. The tension relief units 36.1, 36.2 are intended to at least partially absorb possible tension forces acting on cables extending through the leadthroughs 27, 35.

From the illustration in FIG. 4, it can be seen that the dividing wall 24 has a peripheral rim, which is formed by a web 37. The web 37 engages in a groove 38 of a peripheral seal 39. In the exemplary embodiment illustrated, the top wall, the side walls and the base have a projecting collar, into which the seal 39 is inserted. The rim 30 of the front wall 17 surrounds the seal 39 as well as a collar on the side walls, the top wall and the base. If the front wall is pressed against the seal 39, sealing takes place between the web 37 and the seal 39 as well as between the collar and the seal 39, and the front wall 17 with its rim 30 and the seal 39, thus ensuring that liquid-tight sealing of the interior of the housing is achieved. From the illustration in FIG. 4, it can also be seen that the seal 39 engages behind the dividing wall 24, with the result that it is pressed against an end face of the leadthrough 27. In the region of the second leadthrough 35, a sealing strip 40 is provided on the side of the dividing wall 24 which faces the first chamber 25.1, with the result that the sealing strip 40 is pressed against the second leadthrough 35. Sealing between the sealing strip 40 and the end face of the second leadthrough 35 is thereby achieved.

FIG. 5 shows, on an enlarged scale and in greater detail, the region of the base 21 with a leadthrough 27 having two lead-through openings 31.1, 31.2. As a modification of the embodiment of the leadthrough 27 illustrated in FIG. 4, the leadthrough 27 in the exemplary embodiment illustrated in FIG. 5 has three sealing lips 32.1, 32.2, 32.3.

FIG. 5 shows a tension relief unit 36.1. The tension relief unit is formed by webs 41.1, 41.2 arranged in a V shape relative to one another. The longitudinal rims of the webs 41.1, 41.2 are spaced apart, wherein the distance between the longitudinal rims is smaller than the diameter of the cable, thus ensuring that the longitudinal rims come to rest against the circumferential surface of the cable. The position of a cable 28 is illustrated in dashed lines in FIG. 5.

If a tensile force acts on the cable 28, that is to say a force which is exerted on the cable 28 in a direction away from the base 21, the clamping effect of the longitudinal rims of the webs 41.1, 41.2 is intensified. FIGS. 6 and 7 illustrate an embodiment of a leadthrough 27 of the kind shown in FIG. 4 and FIG. 5, respectively. From the illustration in FIGS. 6 and 7, it can be seen that the leadthrough 27 has a dividing slot 42, which extends from an end face as far as the leadthrough opening 31.2. As a result, there is the possibility, as indicated by the arrows in FIGS. 6 and 7, of opening out the leadthrough 27 to enable cables to be inserted into the leadthroughs 31.1, 31.2. From FIG. 5, it can be seen that a projection 43 extending in the longitudinal direction is provided on one side in the parting plane or parting surface, as FIG. 5 shows. A corresponding slot is provided on the opposite side, thus ensuring that, in the assembled state, the projection 43 engages in the slot, thereby ensuring a seal between the parts of the leadthrough 27 which are formed by the dividing slot 42.

The rim of the leadthrough 27 is provided with a groove 44, in which the rim of an opening in the base 21 engages in the assembled state, as illustrated in FIG. 5. The leadthrough 27 and the opening in the base 21 are configured in such a way that, in the assembled state, a form-fitting and force-fitting connection is formed between the base 21 and the leadthrough 27.

There is the possibility of inserting the cables into the first chamber of the housing in the assembled state of the leadthrough 27. The embodiment of the leadthrough 27 which is illustrated in FIGS. 6 and 7 also opens up the possibility of folding down the leadthrough 27, such that, depending on how many leadthrough openings the leadthrough 27 has, the cable or cables can be installed and the opening in the base 21 can then be formed, and therefore positioning of the cables is already achieved by means of the leadthrough 27. The cable 28 or cables are then also fixed by the tension relief means.

FIG. 8 shows a dividing wall 24. The dividing wall 24 has an opening 26. From FIG. 8, it can be seen that the upper boundary of the opening 26 of the dividing wall 24 is stabilized by a web 45. The opening 27 and the web 45 can also be used to pass through input lines on the left of the web 45 and output lines on the right of the web 45, ensuring that not only color separation of the lines (cables), for example, but also spatial separation of the lines is achieved. The dividing wall 24 can have fastening means in the form of clips etc., which are used to secure electrical units on the dividing wall.

From FIG. 8 and FIG. 9, it can be seen that the dividing wall 24 is provided with a peripheral seal 39. For this purpose, the peripheral seal 39 has a groove 38, in which a web 37 of the dividing wall or of the rim dividing wall engages. The dividing wall 24 can then be connected in a form-fitting and/or force-fitting manner to the box structure, for example.

Another exemplary embodiment of a housing is illustrated in FIG. 10. In this exemplary embodiment, the housing has a front 17 of hood-type configuration and a dividing wall 24 with an opening 26, which is formed at a distance from the base. To seal off the front 17 with respect to the dividing wall 24, a seal 39 is provided, which is designed to run around the periphery. In the exemplary embodiment illustrated in FIG. 10, the box structure 18 has a configuration in which the first chamber, which is formed between the dividing wall 24 and the rear wall, is without a base. A cable 28 extends through two rows of leadthroughs 27.1, 27.2, which are situated at a distance from one another in a vertical plane. FIG. 10 contains an indication of how the cable 28 can extend from the first chamber, through the opening 26, into the second chamber.

The leadthrough 27.1 or 27.2 is illustrated in FIG. 11. The leadthrough 27.1 is designed in such a way that, when viewed in the longitudinal direction of the cable, it has two holding elements 46.1, 46.2 arranged one behind the other. From FIG. 11, it can be ascertained that each holding element 46.1, 46.2 has a groove 47.1, 47.1. In the exemplary embodiment according to FIG. 11, the holding element has a plurality of grooves 47.1, 47.2 formed at a distance from one another. The number of grooves corresponds to the number of cables to be laid. The illustration according to FIG. 11 also shows that the holding elements 46.1, 46.2 are frustopyramidal and of trapezoidal design in cross section. A correspondingly designed sealing element 48.1 can be inserted between the holding elements 46.1, 46.2. A sealing element 48.1 of this kind is illustrated in FIG. 12. The sealing element 48.1 has a number of passages 49.1, 49.2 which corresponds to the number of grooves 47.1, 47.2 and the diameter of which is preferably somewhat smaller than the diameter of a cable to be passed through the passages.

From FIG. 12, it can also be seen that a slot 51.1, 51.2 starting from a surface 50 and extending into the respective passage 49.1, 49.2 is provided. A cable can be inserted through the slot into the passage.

The contour or cross section of the sealing element is matched to the contour of the holding elements 46.1, 46.2, thus ensuring that the holding elements 46.1, 46.2 and the sealing . element 48.1 are pressed against one another in the assembled state, and sealing of the cable is thus achieved.

A modification of this principle is illustrated in FIG. 13. In this exemplary embodiment, two sealing elements 48.1, 48.2 are arranged one behind the other in the longitudinal direction of the cable 28. The holding element is inserted between these two sealing elements.

FIG. 13 and FIG. 10 show leadthroughs 27.1, 27.2 arranged spaced apart.

Another embodiment of the housing is illustrated in FIG. 14. In this exemplary embodiment, the rear wall 22 is connected detachably to the side walls and the top wall. The dividing wall 24 is formed integrally with the side walls and the base. The leadthroughs 27.1, 27.2 are formed between the dividing wall 24 and the rear wall 22. In the exemplary embodiment illustrated, holding element 48,1 and holding element 48.2, which is arranged at a distance from holding element 48.1 in the vertical direction, can be secured on the rear wall, for example. Sealing element 48.1 is secured on the dividing wall 24. This also applies to sealing element 48.2. For assembly, the cables 28 can be inserted into the holding elements 46.1, 46.2 when the rear wall 22 has already been installed at a suitable point, for example. The position of the holding elements 46.1, 46.2 and of the sealing elements 48.1, 48.2 is chosen in such a way that, when the side walls and the top wall are connected to the rear wall, which has a peripheral rim that fits around the side walls and the top wall, they, that is to say the leadthroughs 27.1, 27.2, have a sealing effect on the cables 28.

Finally, the cables can be connected to the corresponding electrical units situated in the second chamber.

The invention not only has the advantage that a risk of electrical faults due to water ingress into the housing is avoided; the invention also has the advantage that the assembly effort is reduced. In particular, it is not absolutely essential that a multiplicity of different tools is required to insert the lines into the housing in a sealing manner.

### LIST OF REFERENCE SIGNS

1 milking station
2 grating structure
3.1, 3.2 posts
4.1, 4.2 tubes
5 milking unit
6.1, 6.2 milking cups
7.1, 7.2 short milk hose
8 milk collector
9 long milk hose
10 pulsator
11.1, 11.2 cables
12 housing
13 operating terminal
14.1, 14.2 signal line
15 operating buttons
16 display
17 front
18 box structure
19.1, 19.2 side wall
20 top wall
21 base
22 rear wall
23 interior
24 dividing wall
25.1 first chamber
25.2 second chamber
26 opening
27 leadthrough
27.1, 27.2 leadthrough
28 cable
29 electrical unit
30 rim
31.1, 31.2 leadthrough opening
32.1-32.4 sealing lip
33 seal pair
34 seal pair
35 leadthrough
36.1 first tension relief unit
36.2 second tension relief unit
37 web
38 groove
39 seal
40 sealing strip
41.1, 41.2 web
42 dividing slot
43 projection
44 groove
45 web
46.1, 46.2 holding element
47.1, 47.2 groove
48.1 sealing element
49.1, 49.2 passage
50 surface
51.1, 51.2 slot

1. A milking device comprising:
a milking unit; and
at least one electrical unit connected to the milking unit and arranged in a housing,
wherein the housing has an interior, which is delimited by a front and a box structure and has a first and a second chamber,
wherein the first and the second chamber are connected to one another at a distance from a base region,
wherein the first chamber has a sealing leadthrough, through which a cable extends into the second chamber, and
wherein the electrical unit is arranged in the second chamber and connected to the cable.

2. The milking device as claimed in claim 1, wherein the cable extends through at least two leadthroughs arranged spaced apart from one another.

3. The milking device as claimed in claim 1, wherein the leadthrough has at least two sealing lips, which are spaced apart from one another and fit around the cable.

4. The milking device as claimed in claim 1, wherein the leadthrough has a holding element and a sealing element, wherein the holding element has a groove which fits partially around the cable, and wherein the sealing element has a passage, through which the cable extends.

5. The milking device as claimed in claim 4, wherein the sealing element has a slot that extends from the surface of the sealing element into the passage.

6. The milking device as claimed in claim 4, wherein a sealing element is arranged between two holding elements when viewed in the longitudinal direction of the cable.

7. The milking device as claimed in claim 1, wherein a dividing wall, which has at least one opening formed in the top region and divides the interior of the housing into the first and second chambers is provided.

8. A housing for accommodating an electrical unit of a milking device, comprising:
an interior, which is delimited by a front and a box structure and has a first and a second chamber
wherein the first and the second chamber are connected to one another at a distance from a base region,
wherein the first chamber has a sealing leadthrough, through which a cable can be inserted into the second chamber, and
wherein the second chamber has fastening means for fastening the electrical unit.

9. The housing as claimed in claim 8, wherein the cable extends through at least two leadthroughs arranged spaced apart from one another.

10. The housing as claimed in claim 8, wherein the leadthrough has at least two sealing lips, which are spaced apart from one another and fit around the cable.

11. The housing as claimed in claim 8, wherein the leadthrough has a holding element and a sealing element, wherein the holding element has a groove which fits partially around the cable, and wherein the sealing element has a passage, through which the cable extends.

12. The housing as claimed in claim 11, wherein the sealing element has a slot that extends from the surface of the sealing element into the passage.

13. The housing as claimed in claim 11, wherein a sealing element is arranged between two holding elements when viewed in the longitudinal direction of the cable.

14. The housing as claimed in claim 8, wherein a dividing wall, which has at least one opening formed in the top region and divides the interior of the housing into the first and second chambers, is provided.
